(19) United States
(12) Patent Application Publication
(10) Pub. No.: US 2014/0297499 A1
(43) Pub. Date: Oct. 2, 2014

(54) SYSTEM FOR ANALYZING CHARACTERISTICS OF STOCK INFORMATION IN CONJUNCTION WITH BASEBALL TERMINOLOGY, AND METHOD FOR PROVIDING THE CHARACTERISTICS

(71) Applicant: Young-Joo O, Seoul (KR)

(72) Inventor: Young-Joo O, Seoul (KR)

(21) Appl. No.: 14/118,486

(22) PCT Filed: May 16, 2012
(86) PCT No.: PCT/KR2012/003851

§ 371 Date: Nov. 18, 2013

(30) Foreign Application Priority Data
May 20, 2011 (KR) 10-2011-0048045
Mar. 22, 2012 (KR) 10-2012-0029261

(51) Int. Cl. G06Q 40/04

(52) U.S. Cl. CPC G06Q 40/04
USPC 705/37

(57) ABSTRACT

Provided are a system and method which enable the formation of a correlation between information on stock transactions and baseball terminology in order to express the information, thereby facilitating the understanding of the characteristics of stock transactions via the characteristics of baseball terminology, and more particularly, to a system and method for more easily relaying information to stock investors using a system that links the results of the inherent transaction prices of stocks to terminology having similar meanings to terminology used in baseball.

### BACKGROUND OF THE INVENTION

The present invention relates to a system and method that represent securities transaction-related information with the securities transaction-related information associated with corresponding baseball terminology, thereby enabling the securities transaction-related characteristics to be easily understood based on the characteristics of baseball terminology and, more particularly, to a system and method that enable information to be more easily delivered to securities investors via a system for associating transaction market price results unique to securities with terminology having similar meanings that is used in baseball.

In general, as for stock, futures and option trades as well as bond and currency trades, online cyber trading is considerably increasing thanks to the development of communication technology and computation programs. The reason why cyber trading is increasing is that cyber trading has many advantages, including excellent accessibility attributable to use of a personal computer (PC), the provision of various types of stock price information, the real-time learning accessing of market prices, rapid purchase and sale ordering, etc.

Individual investors who make stock trade and investment decisions do not have expertise to such an extent as to want additional investment education, do not trust securities company analysts, and make trade decisions using last minute information delivered by various types of media as investment reference information. As a result, they mostly experience investment loss. Accordingly, there is a need for more effective stock trade analysis.

Meanwhile, analysis methods for stock trading chiefly include fundamental analysis and technical analysis. Although these have a complementary relationship, technical analysis is chiefly used. In this case, fundamental analysis analyzes the intrinsic value of the economy in terms of a macroscopic perspective and the intrinsic value of a specific company in terms of a microscopic perspective. In this sense, individual investors are in the situation of the serious asymmetry of information compared to large-scale investment organizations or professional analysts. Although the same information is given, it is difficult for individual investors to have the ability to correctly analyze the information. As a result, although individual investors are at a disadvantage, they generally use information released by financial institutions or media instead of fundamental analysis and depend on technical analysis as a tool for establishing investment and using criteria.

Technical analysis is recognized as a stock price analysis method that is performed by small-scale investors based on the analysis of charts and the like on the assumption that stock price fluctuation reflects all information. Technical analysis refers to a method that predicts future stock prices by analyzing the past and current flows of stock prices and the amounts of trade of stocks. This is a traditional securities analysis method, and a method that predicts future stock prices by ascertaining the trend of stock price fluctuation using data, such as the past prices and past amounts of trade of stocks. In the case of this technical analysis, the method of the analysis is inaccessible to stock trade beginners because the method of the analysis is difficult and complicated, and it takes a long period of time to analyze the general characteristics of items because the number of listed enterprises is larger than 2,000 in Korea.

Furthermore, technical analysis has the problem of requiring investors to be highly trained and have real trade experiences because it is necessary to accurately understand and utilize tens of types of charts, such as candlestick charts, bar charts, comparison charts, sale line charts, flow charts, one-glance equilibrium charts and the like, and about 300 auxiliary indices and hundreds of thousands of charts are generated by the combinations of the charts.

It is impossible for even professional investors who professionally invest in stocks to analyze all the items, the number of which is larger than 2,000, within a short period of time while changing the variables of auxiliary indices. If 100 graphs are analyzed per day, it takes 20 or more days to analyze KOSPI and KOSDAQ stock price fluctuations. Accordingly, it takes several years to analyze the graphs of fluctuation per month (monthly fluctuation), fluctuation per week (weekly fluctuation), fluctuation per day (daily fluctuation), 60-minute fluctuation, 30-minute fluctuation, 15-minute fluctuation, 10-minute fluctuation, 5-minute fluctuation, and the like. In this case, a number of auxiliary indices should be additionally analyzed, and a new chart should be checked per hour and per minute.

This analysis approach is problematic in that professional investors are required to spend their most daily hours performing stock analysis, stock trade beginners should spend several years and experience the loss of a large amount of capital invested in order to establish their on investment techniques, and investors who have not established investment techniques fail in investing in stocks within several months to several years. These problems make investors have resistance to stock analysis, and also make them perceive stock investment simply as gambling and then participate in stock investment. As a result, there is a need for means that enables common investors to easily understand the characteristics of stocks and to statistically access them.

### SUMMARY OF THE INVENTION

Accordingly, the present invention has been made keeping in mind the above problems occurring in the prior art, and an object of the present invention is to enable stock investors to understand characteristics unique to stocks by means of familiar baseball terminology via a system and method for representing stock information, such as the market price information of stocks, with the stock information associated with baseball terminology having similar concepts.

Another object of the present invention is to provide a system and method that are capable of representing information about stock investment with the information associated with baseball terminology so that investors can easily understand the information.

A further object of the present invention is to provide a system and method that are capable of assisting investors in understanding the characteristics of stock investment items through characteristics with which baseball terminology is associated and in making investment decisions.

Yet another object of the present invention is to overcome the limitations of fundamental analysis and technical analysis, that is, stock investment analysis methods, enable the characteristic of each individual item to be analyzed within a short period of time, allow stock trade beginners to more easily understand stocks, and enable stock experts to understand abstract concepts that have been understood only by presumptions and experiences based on the statistics of characteristics of each stock item, thereby providing a precise and scientific analysis method and also providing a third index for stock investment decisions.

In order to accomplish the above objects, the present invention provides a system for analyzing characteristics of securities information using associated baseball terminology, including an information reception unit configured to receive stock information including market price information of a selected item over a communication network; an information extraction unit configured to output transaction information that is extracted from the stock information received by the information reception unit or that is obtained by computation; a classification and association unit configured to determine a category of preset classification information to which the transaction information received from the information extraction unit belongs and to associate the transaction information with the category; and an output unit configured to output results that are associated by the classification and association unit.

The system may further include a terminology definition unit configured to store the classification information, and terminology corresponding to the classification information; the classification and association unit may load the classification information and the corresponding terminology stored in the terminology definition unit, classify the transaction information received from the information extraction unit based on the classification information, and associate the classified transaction information with a term from the corresponding terminology.

The corresponding terminology may be baseball terminology; and the classification and association unit may classify the transaction information based on the classification information, and associate the classified transaction information with the term from the baseball terminology.

The transaction information may be a fluctuation rate of a stock price, the classification information may the range of a rate of rise, and the term from the baseball terminology may be a hit; and the classification and association unit, if the fluctuation rate of the stock price has risen within the range of a rate of rise in accordance with the classification information, may associate the fluctuation rate of the stock price with the baseball term “hit.”

The transaction information may the fluctuation rate of a stock price, the classification information may be the range of a rate of rise to an upper price limit, and the term from the baseball terminology may be a home run; and the classification and association unit, if the fluctuation rate of the stock price has risen to an upper price limit in accordance with the classification information, may associate the fluctuation rate of the stock price with the baseball term “home run.”

The transaction information may be the fluctuation rate of a stock price, the classification information may be part of the range of a rate of rise, and the term from the baseball terminology may be an n-base hit (where n is one of 1 to 3); and the classification and association unit, if the fluctuation rate of the stock price has risen to a specific range of the part of the range of the rate of rise in accordance with the classification information, may associate the fluctuation rate of the stock price with the baseball term “n-base hit.”

The transaction information may the fluctuation rate of a stock price per trade date, the classification information may be a value obtained by dividing a number of dates on which the stock price has risen during a predetermined number of trade dates by a number of trade dates, and the term from the baseball terminology may be a batting average; and the classification and association unit may obtain a value by dividing a number of dates on which the stock price has risen during a specific number of trade dates by a number of trade dates based on the fluctuation rate of the stock price per trade date in accordance with the classification information, and may associate the obtained value with the baseball term “batting average.”

The transaction information may be a fluctuation rate of a stock price per trade date, the classification information may be the rates of rise at which the stock price has risen for a predetermined number of trade dates or a sum of the rates of rise, and the term from the baseball terminology may be a score; and the classification and association unit may obtain rates of rise at which the stock price has risen during a specific number of trade dates or a sum of the rates of rise based on the fluctuation rate of the stock price per trade date in accordance with the classification information, and may associate the obtained values or value with the baseball term “score.”

The transaction information may be a fluctuation rate of a stock price per trade date, the classification information may be a value obtained by summing rates of rise at which the stock price has risen during a specific number of trade dates and then dividing the sum by a number of risen trade dates, and the term from the baseball terminology may be an average score; and the classification and association unit may obtain a value by summing rates of rise at which the stock price has risen during a specific number of trade dates and dividing the sum by a number of risen trade dates based on the fluctuation rate of the stock price per trade date in accordance with the classification information, and may associate the value with the baseball term “average score.”

The transaction information may be the fluctuation rate of a stock price, the classification information may be the range of rates of rise and fall, and the term from the baseball terminology may be a bunt; and the classification and association unit, if the fluctuation rate of the stock price indicates that an opening price was below a steady level and a closing price has risen above the steady level in accordance with the classification information, may associate the fluctuation rate of the stock price with the baseball term “bunt.”

The transaction information may be the fluctuation rate of a stock price, the classification information may be a range of rates of rise and fall, and the term from the baseball terminology may be a bunt failure; and the classification and association unit, if the fluctuation rate of the stock price indicates that an opening price was above a steady level and a closing price has fallen below the steady level in accordance with the classification information, may associate the fluctuation rate of the stock price with the baseball term “bunt failure.”

The transaction information may be a fluctuation rate of a stock price, the classification information may be two partial ranges of a range of rates of rise, and the term from the baseball terminology may be a steal; and the classification and association unit, if the fluctuation rate of the stock price indicates that a rate of rise of an opening price was within a first range and a rate of rise of a closing price has risen to a second range in accordance with the classification information, may associate the fluctuation rate of the stock price with the baseball term “steal.”

The transaction information may be a fluctuation rate of a stock price, the classification information may be a partial range of a rate of rise, and the term from the baseball terminology may be a home steal; and the classification and association unit, if the fluctuation rate of the stock price indicates that a rate of rise of an opening price was in a first range and a rate of rise of a closing price has risen to a price limit in accordance with the classification information, may associates the fluctuation rate of the stock price with the baseball term “home steal.”

The transaction information may be the fluctuation rate of a stock price, and the term from the baseball terminology may be an n-base hit (where n is one of 1 to 3) if the classification information is a partial range of a rate of rise and a home run if the classification information is a range of a rate of rise to an upper price limit; and the classification and association unit, if the fluctuation rate of the stock price has risen to a specific partial range of a range of a rate of rise in accordance with the classification information, may associate the fluctuation rate of the stock price with the baseball term “n-base hit,” if the fluctuation rate of the stock price has risen to an upper price limit in accordance with the classification information, may associate the fluctuation rate of the stock price with the baseball term “home run,” and may obtain a value by summing products of weights corresponding the n-base hit and the home run and dividing the sum by a number of trade dates and then associates the value with the baseball term “slugging percentage.”

The classification and association unit may obtain a value by dividing a number of hit dates by a number of trade dates, and may associate the value with the baseball term “on-base percentage.”

The classification and association unit may associate the number of consecutive hit dates accumulated for a predetermined number of trade dates starting from a most recent date in a reverse direction, with the baseball term “consecutive hits.”

The classification and association unit may associate the number of consecutive home run dates accumulated for a predetermined number of trade dates starting from a most recent date in a reverse direction, with the baseball term “consecutive home runs.”

The classification and association unit may obtain a value by dividing the number of trade dates on which the stock price has belonged to a specific partial range of the range of a rate of rise and a closing price has corresponded to the home run by the number of trade dates on which the stock price has belonged to the specific range, and may associate the value with the baseball term “batting average in scoring position.”

The transaction information may be the fluctuation rate of a stock price, the classification information may the range of a rate of fall, and the term from the baseball terminology may be an out; and the classification and association unit, if the fluctuation rate of the stock price has fallen to the range of the rate of fall in accordance with the classification information, may associate the fluctuation rate of the stock price with the baseball term “out.”

The transaction information may be the fluctuation rate of a stock price, the classification information may be part of a range of a rate of fall, and the term from the baseball terminology may be a strikeout, a double play or a triple play; and the classification and association unit, if the fluctuation rate of the stock price has fallen to a specific partial range of a range of a rate of fall in accordance with the classification information, may associate the fluctuation rate of the stock price with the baseball term “strikeout,” “double play” or “triple play.”

The transaction information may be the fluctuation rate of a stock price, the classification information may be the range of rates of rise and fall, and the term from the baseball terminology may be a win or a defeat; and the classification and association unit, if the fluctuation rate of the stock price has risen in accordance with the classification information, may associate the fluctuation rate of the stock price with the baseball term “win,” and, if the fluctuation rate of the stock price fallen in accordance with the classification information, may associate the fluctuation rate of the stock price with the baseball term “defeat.”

The transaction information may be a fluctuation rate of a stock price, the classification information may be the range of rates of rise and fall, and the term from the baseball terminology may be a shutout or a shutout defeat; and the classification and association unit, if an opening price, low price, high price, closing price of the stock price have risen to an upper price limit, may associate the fluctuation rate of the stock price with the baseball term “shutout,” and, if an opening price, low price, high price, closing price of the stock price have fallen to a lower price limit, may associate the fluctuation rate of the stock price with the baseball term “shutout defeat.”

The transaction information may be the fluctuation rate of a stock price per trade date, the classification information may be the rates of fall at which the stock price has fallen for a predetermined number of trade dates or a sum of the rates of fall, and the term from the baseball terminology may be a lost score; and the classification and association unit may obtain the rates of fall at which the stock price has risen during a specific number of trade dates or a sum of the rates of fall based on the fluctuation rate of the stock price per trade date in accordance with the classification information, and may associate the obtained values or value with the baseball term “lost score.”

The transaction information may be the fluctuation rate of a stock price per trade date, the classification information may be a value obtained by dividing rates of fall at which the stock price fallen during a specific number of trade dates or the sum of the rates of fall by a number of fallen trade dates, and the term from the baseball terminology may be an earned run average; and the classification and association unit may obtain a value by dividing rates of fall at which the stock price has fallen during a specific number of trade dates or the sum of the rates of fall by a number of fallen trade dates based on the fluctuation rate of the stock price per trade date in accordance with the classification information, and may associate the value with the baseball term “earned run average.”

The transaction information may be the fluctuation rate of a stock price, the classification information may be the range of a rate of fall to a lower price limit, and the term from the baseball terminology may be a home run allowed; and the classification and association unit, if the fluctuation rate of the stock price has fallen to a price limit in accordance with the classification information, may associate the fluctuation rate of the stock price with the baseball term “home run allowed.”

The transaction information may be the fluctuation rate of a stock price, the classification information may be the range of rates of rise and fall, and the term from the baseball terminology may be a draw; and the classification and association unit, if the fluctuation rate of the stock price was at a steady level in accordance with the classification information, may associate the fluctuation rate of the stock price with the baseball term “draw.”

The classification and association unit may associate a value obtained by dividing a number of winning dates by the sum of the number of winning dates and the number of defeating dates with the baseball term “winning rate.”

The transaction information may be the fluctuation rate of a stock price, the classification information may be the range of rates of rise and fall, and the term from the baseball terminology may be a save; and the classification and association unit, if an opening price of the stock price was within a rise range and a closing price has been equal to or has risen above the opening price, may associate the fluctuation rate of the stock price with the baseball term “save.”

The classification and association unit may associate the number of consecutive save dates accumulated for a predetermined number of trade dates starting from the most recent date in a reverse direction, with the baseball term “consecutive saves.”

The transaction information may be the fluctuation rate of a stock price, the classification information may be the range of rates of rise and fall, and the term from the baseball terminology may be a blown save; and the classification and association unit, if an opening price of the stock price was in the range of rise and a closing price thereof has fallen below the opening price, may associate the fluctuation rate of the stock price with the baseball term “blown save.”

The transaction information may be the fluctuation rate of a stock price, the classification information may be the range of rates of rise and fall, and the term from the baseball terminology may be an away win; and the classification and association unit, if the stock price has risen on a trade date on which a composite stock index has fallen, may associate the fluctuation rate of the stock price with the baseball term “away win.”

The classification and association unit may obtain a value by dividing a number of away win dates for a predetermined number of dates by a number of dates on which a composite stock index has fallen, and may associate the value with the baseball term “away winning rate.”

Additionally, the present invention provides a method of analyzing characteristics of securities information using associated baseball terminology, including (1) receiving, by an information reception unit of a user terminal, receiving stock information including market price information of a selected item over a communication network; (2) outputting, by an information extraction unit, transaction information that is extracted from the stock information received by the information reception unit or that is obtained by computation; (3) determining, by a classification and association unit, a category of preset classification information to which the transaction information received from the information extraction unit belongs, and associating, by the classification and association unit, the transaction information with the category; and (4) outputting, by an output unit, results that are associated by the classification and association unit.

A terminology definition unit may store the classification information and terminology corresponding to the classification information; the classification and association unit may load the classification information and the corresponding terminology stored in the terminology definition unit, may classify the transaction information received from the information extraction unit based on the classification information, and may associate the classified transaction information with a term from the corresponding terminology.

The corresponding terminology may be baseball terminology; and the classification and association unit may classify the transaction information based on the classification information, and may associate the classified transaction information with the term from the baseball terminology.

The present invention has the advantage of enabling stock investors to easily understand characteristics unique to stock items through familiar baseball terminology.

Furthermore, the present invention has the advantage of enabling investors to understand the characteristics of stock investment items through characteristics with which baseball terminology is associated and to make investment decisions.

Furthermore, the present invention has the advantage of enabling beginning investors who do not know stock investment information well to easily understand and analyze characteristics unique to stock items.

Furthermore, the present invention has the advantage of enabling item characteristics to be analyzed and understood within a short period of time because baseball terminology that can be easily understood is utilized.

Furthermore, the present invention has the advantage of enabling item characteristics to be easily analyzed based on objective indices, thereby enabling stock trade beginners to select items using their own analysis ability, in addition to traditional analysis methods.

Furthermore, the present invention has the advantage of providing distinction indices that enable the characteristics of items to be compared with each other and facilitating the comparison.

Furthermore, the present invention has the advantage of assisting investors in selecting items that are suitable for their individual trading styles.

### BRIEF DESCRIPTION OF DRAWINGS

FIG. 1 is a diagram illustrating the connections of a general HTS system;

FIG. 2 is a diagram illustrating the configuration of a system according to the present invention using blocks;

FIG. 3 is a flowchart illustrating a method of analyzing and providing characteristics according to the present invention;

FIGS. 4 to 15 are tables illustrating embodiments of classification information, corresponding baseball terminology and computation equations stored in the terminology definition unit of the present invention;

FIGS. 16 and 17 are diagrams illustrating the analysis results of an item in accordance with the present invention using a baseball field and corresponding baseball terminology; and

FIG. 18 is a table illustrating a first item and a 300th item for each category analyzed in accordance with the present invention.

### DESCRIPTION OF REFERENCE NUMERALS OF PRINCIPAL ELEMENTS IN THE DRAWINGS

10: information reception unit
20: information extraction unit
30: classification and association unit
40: output unit
50: terminology definition unit
60: display terminal

### DETAILED DESCRIPTION OF THE INVENTION

The configuration of the present invention will be described in detail below with reference to embodiments of the configuration of the present invention illustrated in the accompanying drawings.

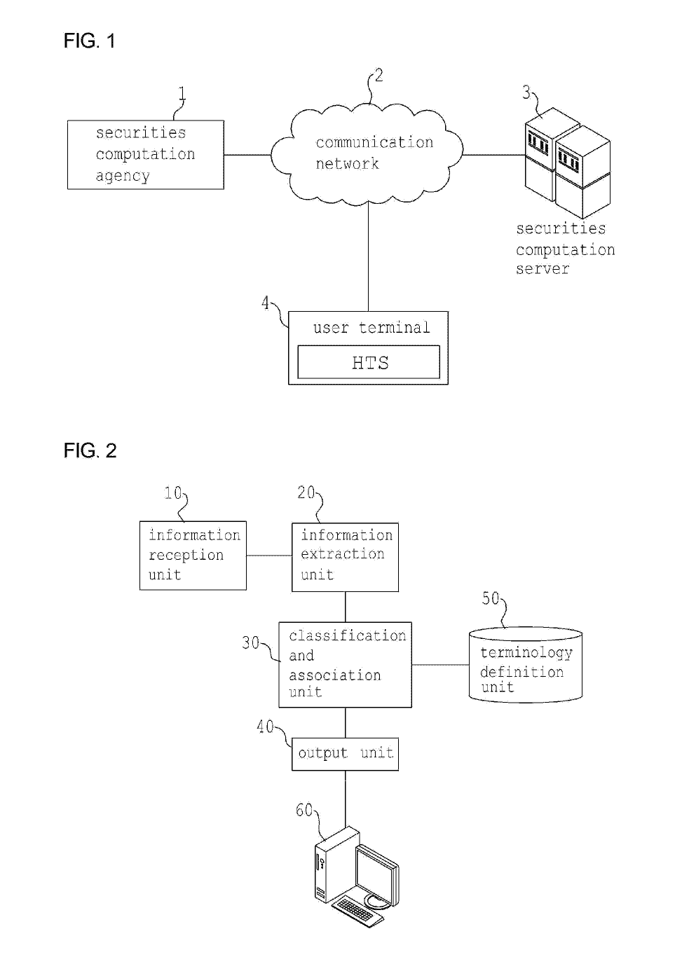

In general, as for stock, futures and option trades as well as bond and currency trades, online cyber trading is considerably increasing thanks to the development of communication technology and computation programs. The reason why cyber trading is increasing is that cyber trading has many advantages, including excellent accessibility attributable to use of a personal computer (PC), the provision of various types of stock price information, the real-time learning of market prices, rapid purchasing and sale ordering, etc. For such transactions, thanks to the rapid development of systems, such as a Home Trading System (HTS), provided by securities companies, the percentage of the online trading of individual investors is continuously increasing. FIG. 1 is a diagram illustrating the connections of a general HTS system. Referring to FIG. 1, various types of stock-related information provided by a securities computation agency 1 are transferred to a securities company server 3 over a communication network 2, and also to a user terminal 4 provided in each of individual homes, securities company branches and offices over the communication network 2, and are displayed to a user through the running of an HTS program, thereby enabling transaction activities, such as the reception of various types of transaction information.

In spite of the convenience of this system, most of various types of information handled and provided by this system are contents that cannot be easily understood by investors unless they have been highly trained previously.

For this reason, the present invention provides a system and method for associating stock concepts with baseball concepts, and is advantageous in that the item characteristics of each item are converted into numerical values and made to be easily understood via baseball terminology.

That is, it takes a long time to perform research into the unique characteristics of each item, the characteristics of the item are not more specifically understood and are superficially understood because they are not converted into data, and there are cases where they are forgotten after a predetermined time has elapsed. In contrast, in accordance with the system of the present invention, all information is explained via baseball terminology at a glance, so that research into item characteristics is not required and the time it takes to perform the research can be considerably reduced.

Meanwhile, there is no question that the most popular sport in Korea is baseball. A great many people know the rules and terms of baseball to a certain extent. If stock information is explained through comparison to baseball, the information can be delivered to stock trade beginners or persons who find it difficult to comprehend various types of theories in an easy and familiar manner. This enables investors to increase their understanding of stock investment and to have the new point of view of statistics.

For this purpose, in the present invention, a basic concept is set up such that individual stock items are considered to be individual baseball players and the individual items enter a baseball field considered to be a stock market and make scores. This enables stock investment to be analyzed through numerical, scientific and statistical means, and also enables stock prices to be predicted through a scientific stock analysis. Through this prediction, the following characteristics of the stocks of each item may be understood and predicted.
The price of stocks of this item rises in the morning and falls in the afternoon (strong and then weak).
The price of stocks of this item is strong in the latter period (weak and then strong).
There are many cases where the opening price of stocks of this item is highest during a day.
Stocks of this item have low opening prices and high closing prices.
The price of stocks of this item has a great fluctuation width during a day.
The price of stocks of this item rises high in summer/winter.
Stocks of this item frequently reach upper limit prices.
The price of stocks of this item frequently reaches an upper limit price, and the upper limit price is easily broken.
The price of stocks of this item always rises when a composite stock price index rises (a proportional correlation with the composite stock price index).
The price of stocks of this item falls when a composite stock price index rises (an inverse proportional correlation with the composite stock price index).
The price of stocks of this item fluctuates along with 00 stock (a correlation with an individual item).
What is the probability that the closing price of this item will be + if the opening price thereof was +?
What is the probability that the closing price of this item will be + if the opening price thereof was + and the opening price of a composite stock price index was +?
What is the probability that the closing price of this item will be + if the opening price was +, the opening price of a composite stock price index was +, and the closing price of the composite stock price index was −?
What is the probability that the closing price of this item is higher than the opening price thereof?
What is the probability that the closing price of this item is + if the opening price of this item was + and was − during trading hours?
What is the probability that the closing price of this item is − if the opening price of this item was − and was + during trading hours?
What is the probability that the closing price of this item will reach an upper limit price if the price thereof reaches an upper limit price during trading hours?
What is the probability that the closing price of this item will reach an upper limit price if the high price thereof reaches an upper limit price during trading hours?
What is the probability that the closing price of this item will reach an upper limit price if the opening price thereof reached an upper limit price?
What is the probability that the price of this will start with + on a subsequent day if the price of this item has fallen for recent 3 consecutive days?

The above-described concepts have been indefinitely considered in the past. In accordance with the present invention, these concepts may be defined by means of corresponding terms. The corresponding terminology that is most suitable for this purpose is baseball terminology. The characteristics that are defined via baseball terminology play a significant role in the establishment of criteria for the classification and distinction of the market price patterns of new items, thereby enabling more excellent item analysis.

This item analysis can be easily understood and extracted by investors via baseball terminology, and the configuration of a system for associating stock information with baseball terminology will be described below.

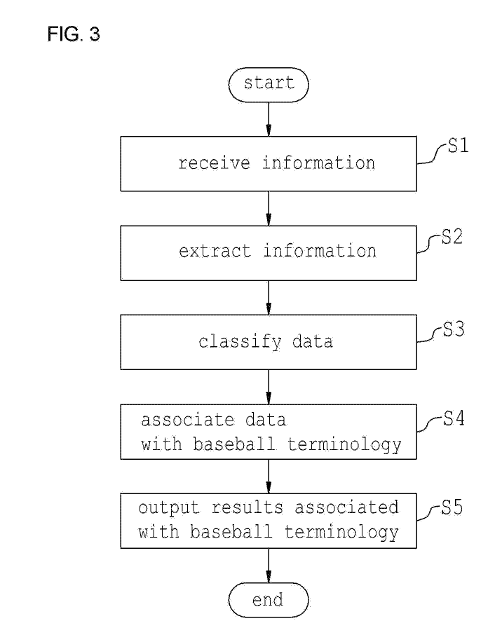

FIG. 2 is a diagram illustrating the configuration of a system according to the present invention using blocks, and FIG. 3 is a flowchart illustrating a method of analyzing and providing characteristics according to the present invention. Referring to FIGS. 2 and 3, the characteristic analysis system is based on a concept including a typical PC, a smart phone, a server system, a wireless terminal, a PDA, a tablet PC, etc. These devices may each function as the characteristic analysis system, or may function as the characteristic analysis system in combination. That is, an information reception unit 10, an information extraction unit 20, a classification and association unit 30, an output unit 40, a terminology definition unit 50 and a display terminal 60 are provided in a single computer terminal, and, when various types of raw data are received by a computer terminal, may perform internal extraction and computation and output and display result values. Alternatively, the information reception unit 10, the information extraction unit 20, the classification and association unit 30, the output unit 40 and the terminology definition unit 50 are provided in a securities company or a service provider server, and output only result values to a server and then display them on another display terminal 60 connected over a communication network. In this case, the server may be responsible for operations up to the computation of the result values, while the user terminal may be responsible only for the display of result values. The modularization and configuration of some elements may be determined in various manners without any limitations depending on technological selection and development.

The information reception unit 10 functions to receive transaction information. Such transaction information is commonly received from the securities computation agency 1 (see FIG. 1) at step S1. The information reception unit 10 receives various types of related stock information that are received by a typical HTS. The received information includes the market price information of each selected item, such as the opening price, high price, low price, closing price, rate of rise, and rate of fall of the selected item based on a trade date. Furthermore, the received information may be related to an individual company item, or an index item, such as a KOSPI, KOSDAQ, or futures index or the like.

The information extraction unit 20 functions to extract necessary transaction information from among the various types of information received through the information reception unit 10, or functions to derive raw data through computation and generate and output necessary transaction information at step S2. For example, the information extraction unit 20 extracts the opening price, high price, low price, and closing price of a specific item on a specific trade date through the selection of them from a vast amount of stock information, or derives the rate of rise through computation using the extracted values. In connection with various market prices and trade data in various time spans received by the information reception unit 10, the information extraction unit 20 extracts selective data or all the data, or edits and computes the data, and provides resulting data to the classification and association unit 30.

The classification and association unit 30 functions to classify or compute various types of data transferred by the information extraction unit 20 according to various types of conditions and equations at step S3. In this case, conditional expressions and computational equations used for classification and computation are loaded from a separate terminology definition unit DB in which expressions and equations have been stored and defined, and processing is performed.

The terminology definition unit 50 stores classification information, such as conditions, equations, etc., required by the classification and association unit 30 and terminology corresponding to corresponding classification information, and provides them. Accordingly, the classification and association unit 30 determines a condition and a defined term to which the market price of a corresponding item corresponds, or determines whether a corresponding item meets a condition that corresponds to a term defined by the terminology definition unit 50.

The classification information stored by the terminology definition unit 50 is associated with terminology corresponding to the classification information, and the classification and association unit 30 performs classification and computation with respect to the classification information, associates results with loaded corresponding terminology, and outputs and expresses them.

The classification and association unit 30 loads the classification information and the corresponding terminology from the terminology definition unit 50, classifies and computes conditions received from the information extraction unit 20 according to the classification information, and associates the conditions with the corresponding terminology. In this case, although the corresponding terminology may be set in various ways, the principal embodiments of the present invention use baseball terminology. The win, defeat and statistical representations of baseball are suitable because they have the same context as the rise, fall and statistics of stocks at step S4. The terminology definition unit 50 stores baseball terminology and corresponding classification information. The terminology and the corresponding classification information may be varied or added by the settings of an administrator.

The associated result values are transmitted from the output unit 40 to the outside, and are finally transferred via the personal terminal of an investor or a display device 60, such as a display or the like. That is, as will be described later, a specific pattern of stock market prices is associated with a term that refers to a specific situation in a baseball game and is output along with its result value at step S5.

The classification information and terminology, that is, baseball terminology, corresponding to the classification information defined by the terminology definition unit 50 will be described, and the definition, the content of the correspondence, and the pattern have unique features.

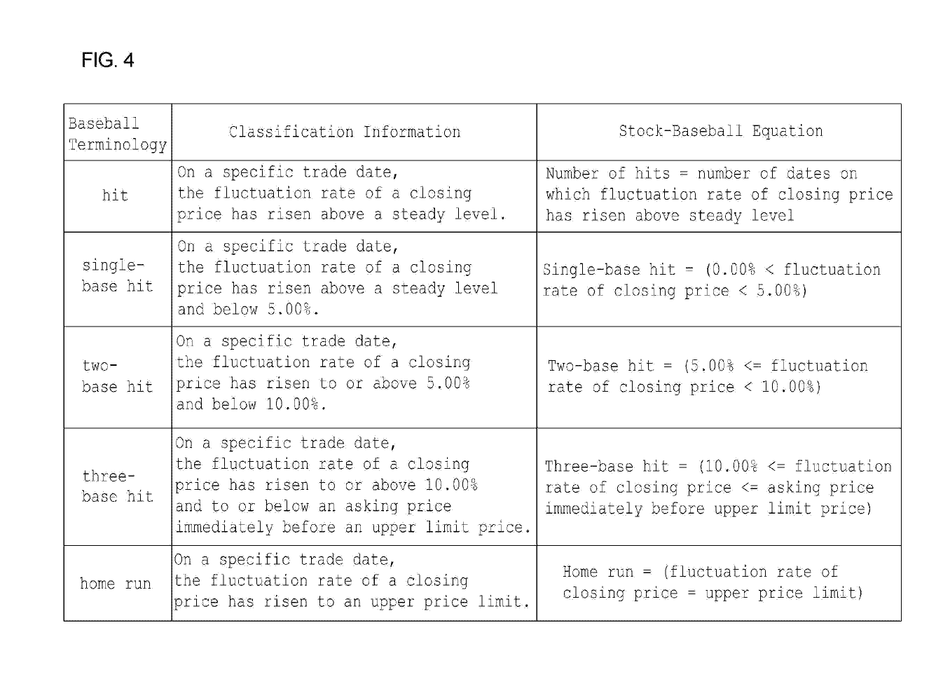

FIGS. 4 to 15 are tables illustrating embodiments of classification information, corresponding baseball terminology and computation equations stored in the terminology definition unit of the present invention. Referring to FIG. 4, the baseball term “hit,” which is a corresponding term, is defined as referring to the case where classification information indicates that a closing price has risen above a steady level on a specific trade date. If transaction information corresponds to this, the result value “hit” is obtained with respect to the transaction information. Although the fluctuation rate of a closing price is taken as an example in this table, the closing price may be replaced with an opening price, a low price, a high price or the like in some cases. Furthermore, the basis of the rise may be a closing price on a previous date or an opening price on a current date. These are the same in the following cases.

For example, if item A has risen by 3%, transaction information corresponds to a rise of 3%, which corresponds to the case where “on a specific trade date, the fluctuation rate of a closing price has risen above a steady level” in terms of classification information. This is associated with “hit,” and is then represented.

Furthermore, as shown in the table, a single-base hit, a two-base hit, and a three-base hit are associated with a rise in the range up to below 5%, a rise in the range up to below 10%, and a rise in the range up to an asking price immediately before an upper limit price below 15%, respectively, and a home run is associated with a rise to an upper limit price, that is, the limit price of a current date.

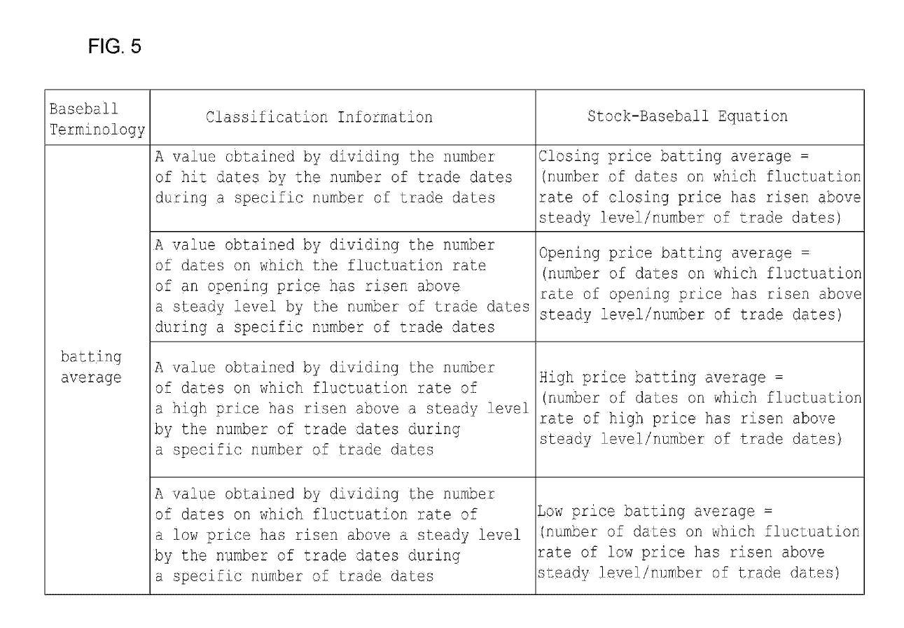

Referring to FIG. 5, the baseball term “batting average,” which is a corresponding term, is a value obtained by dividing the number of hit dates by the number of trade dates, and may be based on the fluctuation rate of an opening price, a high price, or a low price.

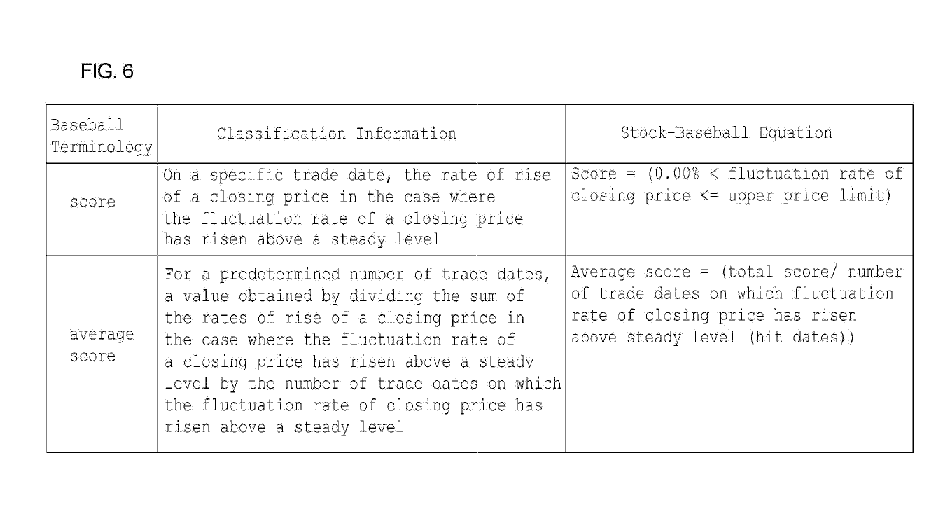

Referring to FIG. 6, the baseball terms “score” and “average score,” which are corresponding terms, refer to the rate of rise of a closing price in the case of closing higher, and a value obtained by dividing the sum of the rates of risen closing prices by the number of risen trade dates, respectively. In this case, the number of trade dates may correspond to the baseball term “the number of games.”

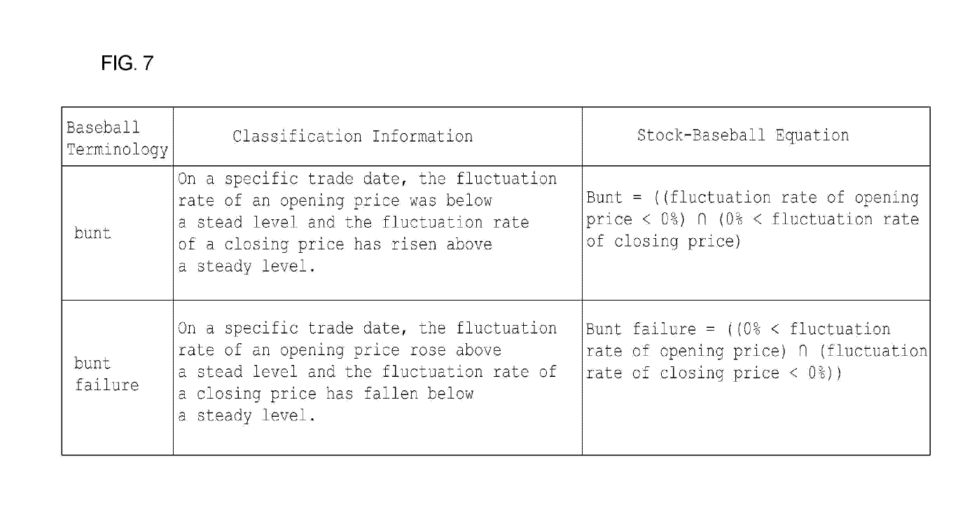

Referring to FIG. 7, the baseball term “bunt,” which is a corresponding term, refers to the case where an opening price was below a steady level but a closing price has risen above the steady level. In contrast, the term “bunt failure” refers to the case where an opening price rose above a steady level but a closing price has fallen below the steady level.

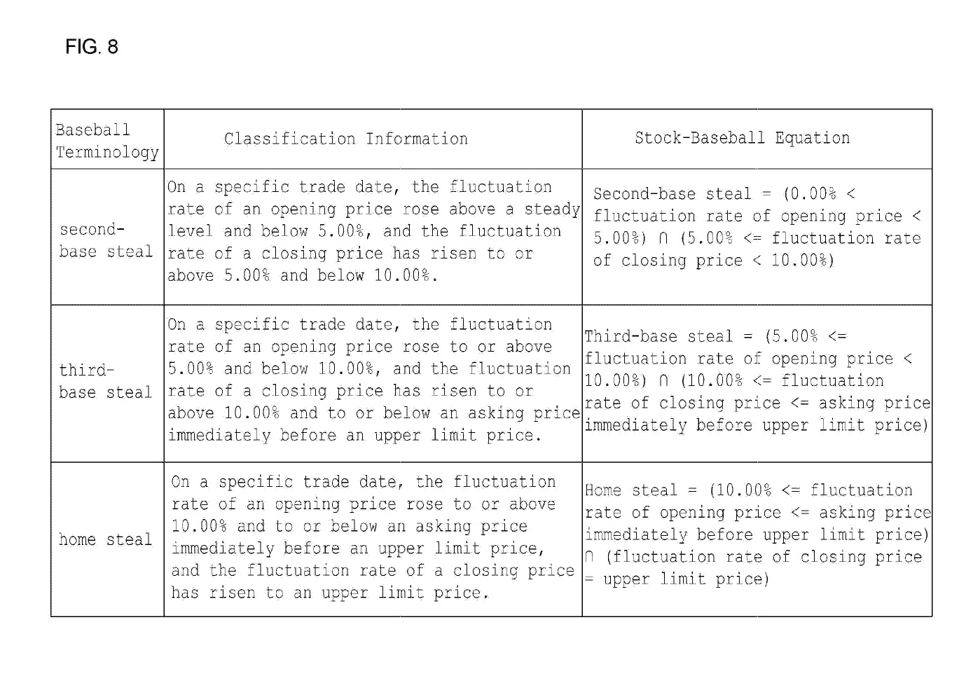

Referring to FIG. 8, the baseball term “steal,” which is a corresponding term, refers to a rise from a specific region to another region. The term “second-base steal” refers to the case where an opening price rose below 5% and a closing price has risen in the range from 5 to below 10%, the term “third-base steal” refers to the case where an opening price rose in the range from 5 to below 10% and a closing price has risen in the range from 10 to an asking price immediately before an upper limit price below 15%, and the term “home steal” refers to the case where an opening price rose in the range from 10 to an asking price immediately before the upper limit price below 15% and a closing price has risen to the upper limit price.

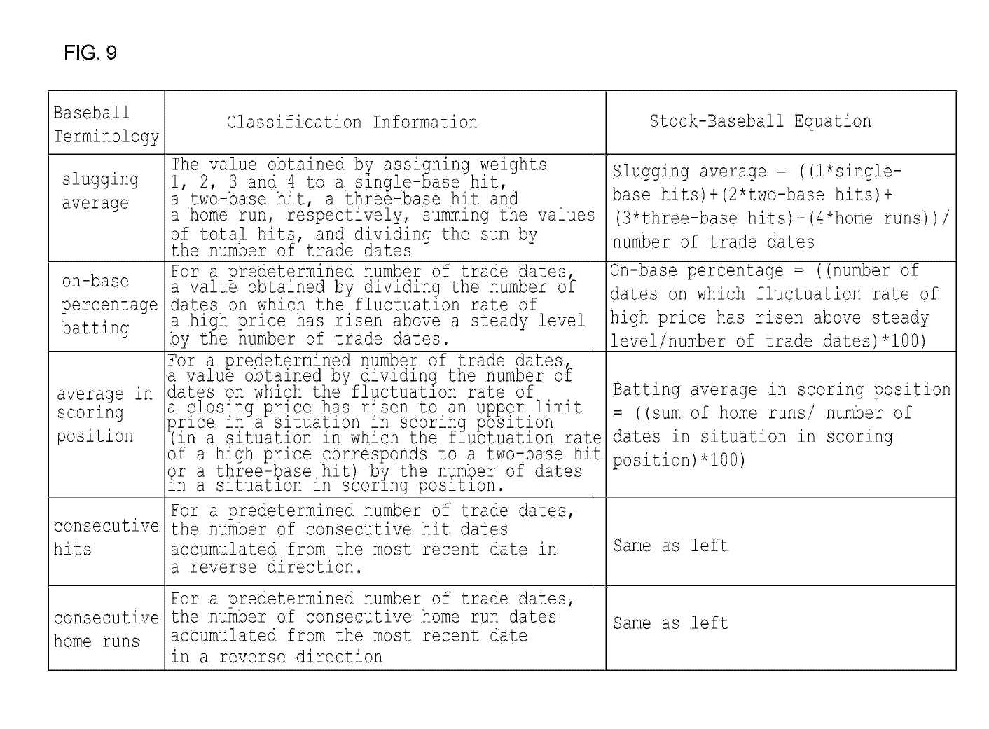

Referring to FIG. 9, the baseball term “slugging percentage,” which is a corresponding term, refers to a value obtained by assigning the weights 1, 2, 3 and 4 to a single-base hit, a two-base hit, a three-base hit and a home run, respectively, summing the weighted scores of all hits and then dividing a total score by the number of trade dates. The term “on-base percentage” refers to a value obtained by dividing the number of dates on which the fluctuation rate of a high price has risen above a steady level during a specific number of trade dates by the number of trade dates. The term “batting average in scoring position” refers to a value obtained by dividing the number of dates on which a closing price has risen to an upper limit price in a situation in which the fluctuation rate of a high price corresponds to a two- or three-base hit by the number of dates in a situation in scoring position. Furthermore, the terms “consecutive hits” and “consecutive home runs” refer to the number of consecutive hit dates and the number of consecutive home run dates that have accumulated from the most recent date in a reverse direction, respectively.

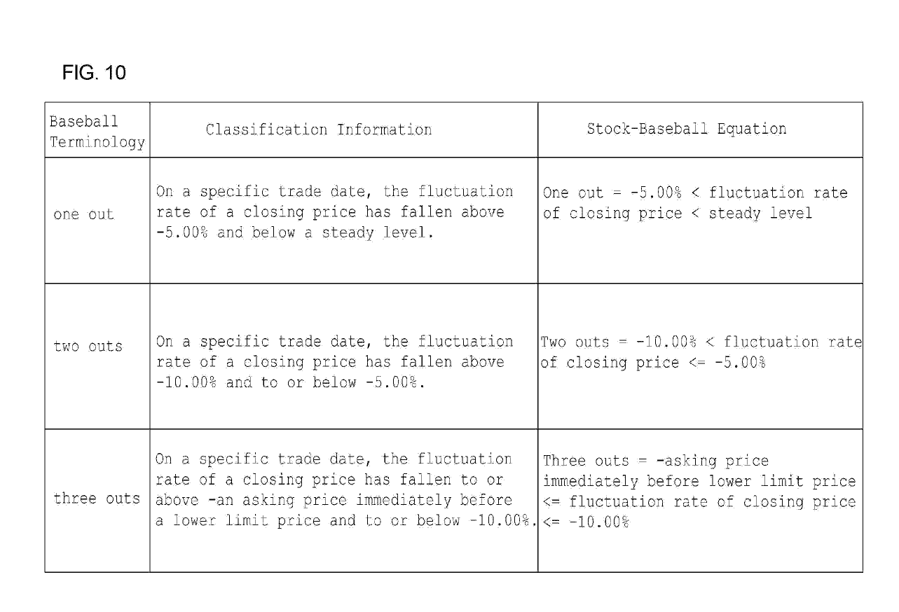

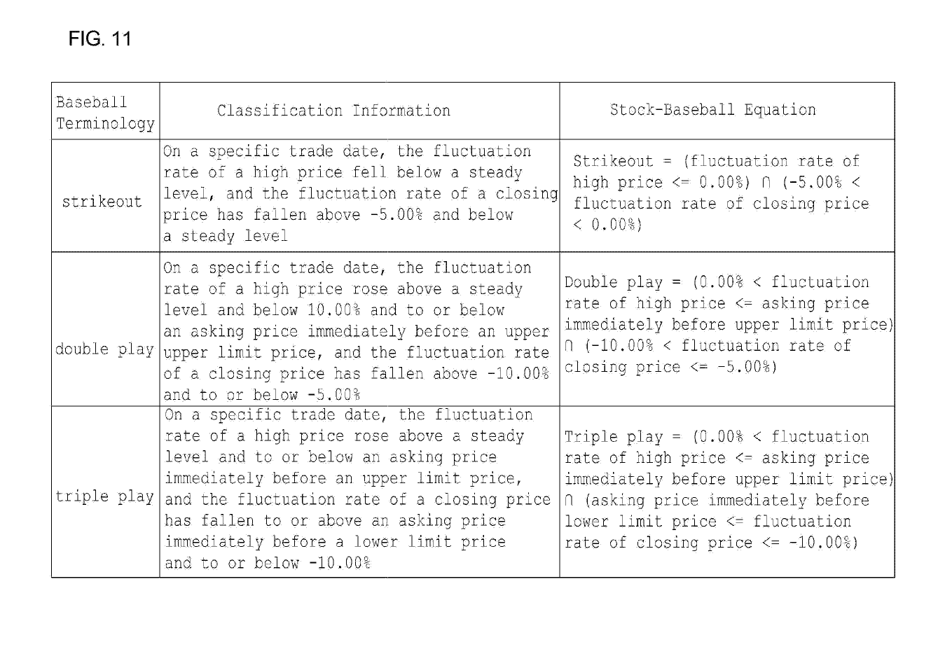

Referring to FIGS. 10 and 11, the baseball term “out,” which is a corresponding term, refers to a fall in a specific range, in contrast with the hit and the base hit. The term “one out” refers to closing lower in the range up to above −5%, the term “two outs” refers to closing lower in the range up to above −10%, and the term “three outs” refers to closing lower to an asking price immediately before a lower limit price.

The term “strikeout” refers to the case where a high price was equal to or lower than a steady level and a closing price has fallen in the range up to above −5%, the term “double play” refers to the case where a high price rose above a steady level and to or below an asking price immediately before an upper limit price and a closing price has fallen in the range from −5 to above −10%, and the term “triple play” refers to the case where a high price rose above a steady level and to or below an asking price immediately before an upper limit price and a closing price has fallen in the range from an asking price immediately before a lower limit price to −10%.

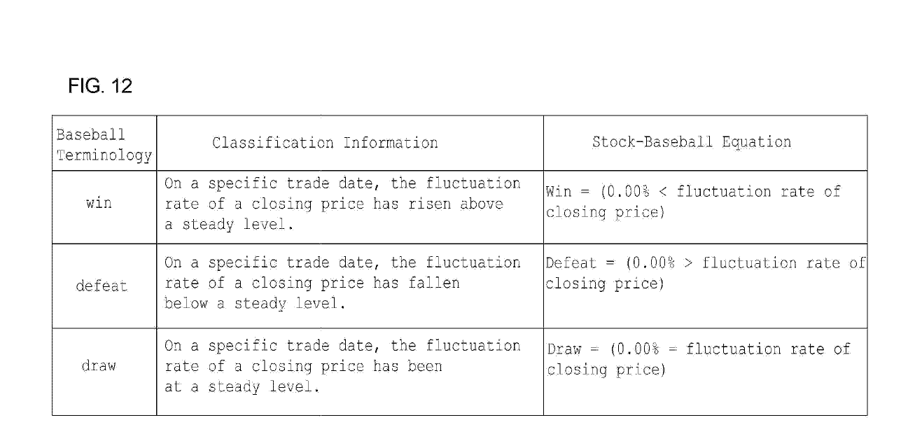

Referring to FIG. 12, the baseball terms “win”, “defeat” and “draw,” which are corresponding terms, refer to the case where a closing price has risen above a steady level, the case where a closing price has fallen below a steady level, and the case where a closing price has been at a steady level.

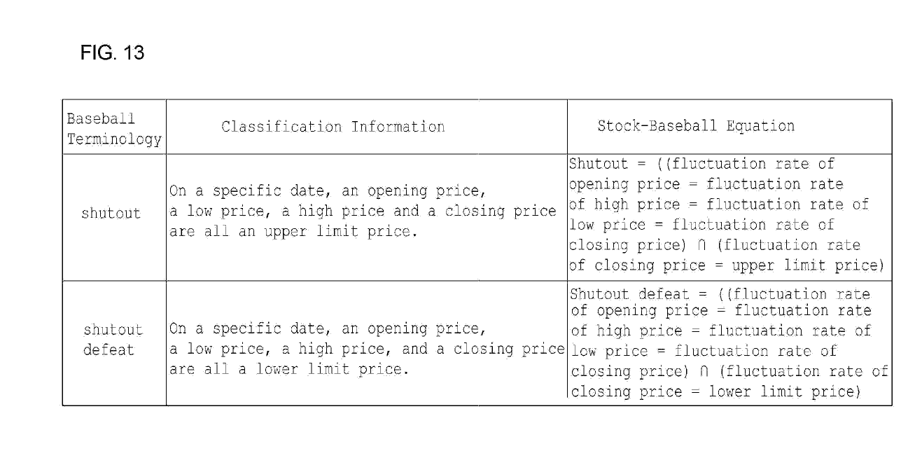

Referring to FIG. 13, the baseball terms “shutout” and “shutout defeat,” which are corresponding terms, refer to the case where an opening price, a low price, a high price and a closing price are all an upper limit price and the case where an opening price, a low price, a high price and a closing price are all a lower limit price, respectively.

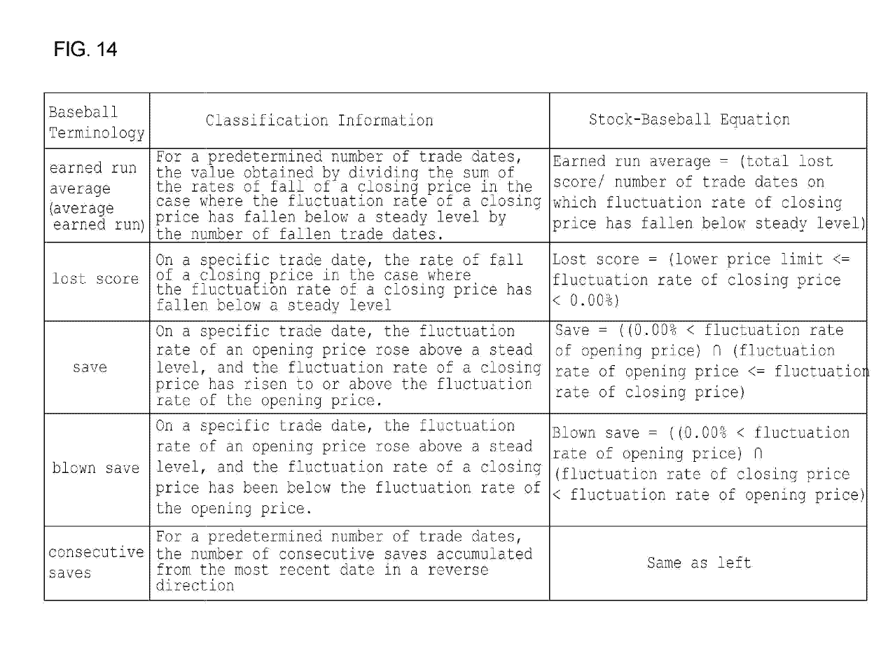

Referring to FIG. 14, the baseball term “earned run average,” which is a corresponding term, refers to a value obtained by dividing the sum of the rates of fall of closing prices in the case where the rates of rise or fall of the closing prices has fallen below a steady level during a specific number of trade dates by the number of fallen trade dates. The term “lost score” refers to the rate of fall of a closing price in the case where the fluctuation rate of a closing price has fallen below a steady level on a specific trade date, the term “save” refers to the case where on a specific trade date, the fluctuation rate of an opening price rose above a steady level and the fluctuation rate of a closing price has risen to or above the fluctuation rate of the opening price, the term “blown save” refers to the case where the fluctuation rate of a closing price has fallen below the fluctuation rate of an opening price. The term “consecutive saves” refers to the number of consecutive saves that have accumulated for a specific number of trade dates starting from the most recent date in a reverse direction.

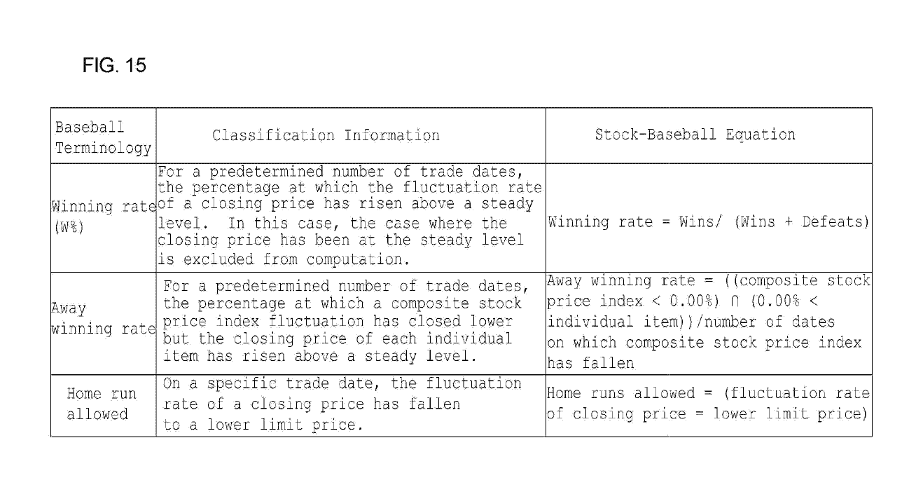

Referring to FIG. 15, the baseball term “winning rate,” which is a corresponding term, refers to the percentage at which the fluctuation rate of a closing price has risen above a steady level during a specific number of trade dates except for the dates on which the fluctuation rate of a closing price is at a steady level, and the term “away winning rate” refers to the percentage at which a composite stock price index has fallen but the closing price of a corresponding item has risen above a steady level. The term “home run allowed” refers to the case where the fluctuation rate of a closing price has been at a lower limit price on a specific trade date.

Meanwhile, in baseball terminology, there are offensive terms, pitcher terms, defensive terms, and catcher terms. These terms may be classified and then appropriately used in connection with a composite stock price index. That is, on a date on which the composite stock price index has risen, offensive terms or pitcher terms may be used. In contrast, on a date on which the composite stock price index has fallen, defensive terms or catcher terms may be used.

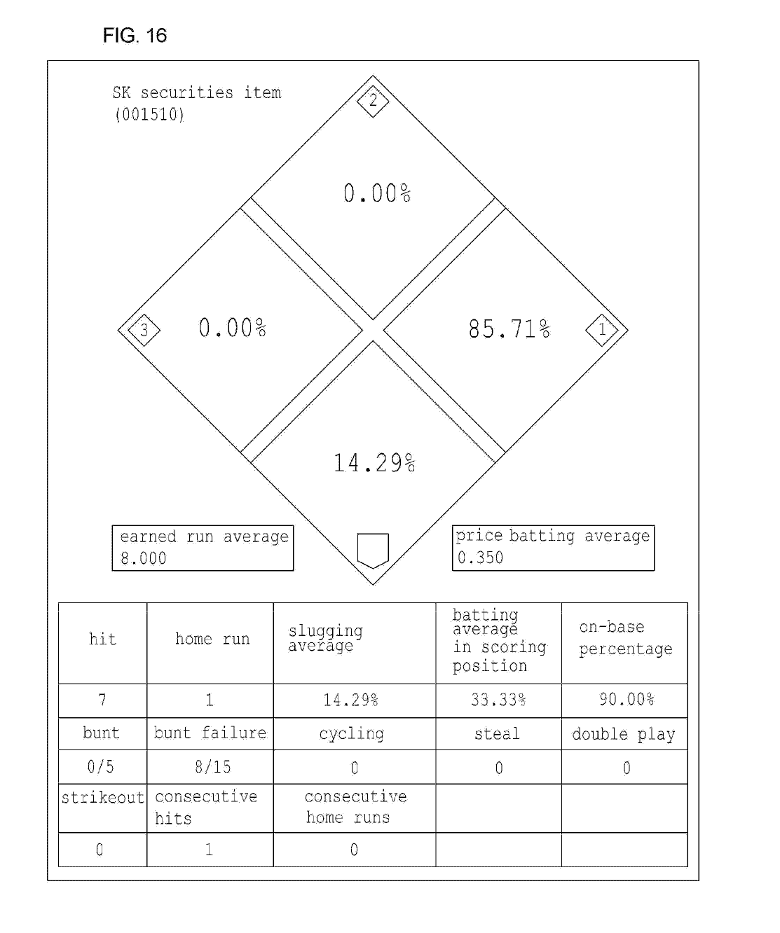

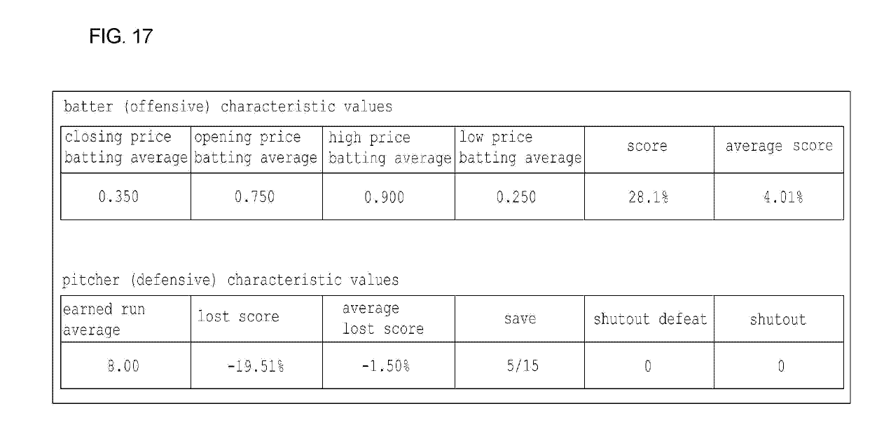

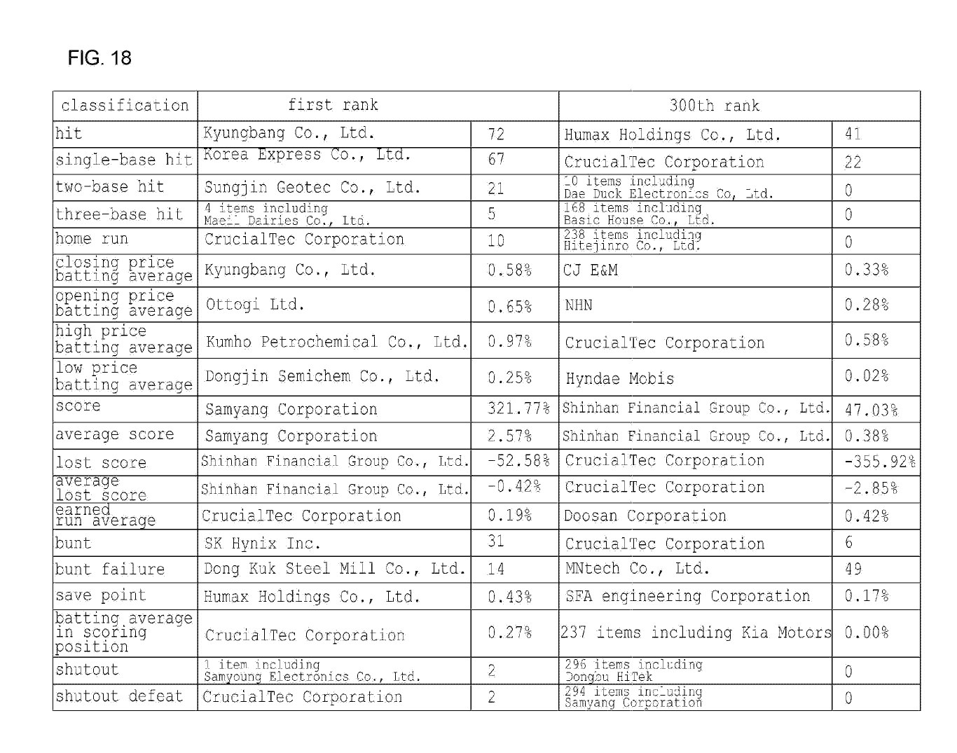

FIGS. 16 and 17 are diagrams illustrating the analysis results of an item in accordance with the present invention using a baseball field and corresponding baseball terminology, and FIG. 18 is a table illustrating a first item and a 300th item for each category analyzed in accordance with the present invention. Referring to FIGS. 16 and 17, result values that are finally output by the output unit 40 are displayed on the display device 60 based on the selection a user, as illustrated in the diagram. Referring to the diagram, the result value are represented using the number of hits, ratio of single-base hits, ratio of two-base hits, ratio of three-base hits, ratio of home runs, number of home runs, slugging percentage, steals, double plays, etc. of a SK securities item. Furthermore, as illustrated in FIG. 17, the numerical value of a batter characteristic value and the numerical value of a pitcher characteristic value may be displayed, which enables investors viewing these values to significantly improve their understanding of the corresponding numerical values in conjunction with images that are associated with baseball terminology.

Furthermore, as illustrated in FIG. 18, via ranking based on each baseball term for a specific period of time, investors are allowed to very easily understand the characteristics of each item. FIG. 18 illustrates the results of actual technical analysis for six months spanning from a specific date with respect to 200 KOSPI items and 100 KOSDAQ items, that is, a total of 300 items, via the baseball terminology of the present invention, particularly the first and 300th ranks of each item. Using this, investors can easily understand the characteristics and contents of a corresponding item at a glance.

Furthermore, it is possible to characterize and classify items using item analysis categories, for example, a historical or per-period largest-number-of-home run category, a highest score category, a highest run batted in (RBI) category, a largest-number-of-hit category, a largest-number-of-steals category, a largest-number-of-consecutive bunt category, a highest slugging percentage category, a highest on-base percentage category, a shortest home run cycle category, a shortest home-run-allowed cycle category, etc., which have not be characterized in the past, and to then provide the characterized and classified information to investors. Therefore, the advantages of improving the understanding of investors and establishing the new definitions and concepts of characteristics are achieved. While there is no method of explaining or specifying these categories simply using only existing stock categories, the present invention enables this explanation and specification. Furthermore, a batting average is represented using a graph, or may be represented in the form of a game. Among all items, leading stocks are discovered through absolute and relative comparisons between business, and leading stocks are discovered within theme stocks as well as between business items through absolute and relative comparisons between within the theme stocks as well as the business items. Furthermore, the present invention functions to assist investors in selecting trade items via statistics that are differentiated for individual stock price trends, such as a bull market trend, a bear market trend, and a steady market trend. Furthermore, via various types of baseball indices, the present invention functions to discover items of similar types and similar scores and to extend the range of couplings of items.

In the above description, the information reception unit, the information extraction unit, the classification and association unit, the output unit, the terminology definition unit and their subordinate elements, that is, the elements of each system, may be separate elements in terms of hardware, may be functional classification-based elements in terms of software, or may be elements that are divided such that a system of a series of pieces of information can be set forth based on individual functions.

In accordance with the system and the provision method, accurate item analysis is enabled, and the utilization of them as indices is increased based on the convenience of computation and awareness. Furthermore, the distortion of indices can be prevented and all content can be understood and comprehended at one time, and thus the utilization of the system and the provision method as a tool for investment decision making increases.

Meanwhile, the present invention is not limited to the above-described typical preferred embodiments, but it will be easily appreciated by those having ordinary knowledge in the art that the present invention may be practiced through various modifications, variations, substitutions or additions within the range that does not depart from the gist of the present invention. If the practice through the modifications, variations, substitutions or additions falls within the scope of the following attached claims, the technical spirit thereof should be considered to also fall within the scope of the present invention.

1. A system for analyzing characteristics of securities information using associated baseball terminology, comprising:
an information reception unit configured to receive stock information including market price information of a selected item over a communication network;
an information extraction unit configured to output transaction information that is extracted from the stock information received by the information reception unit or that is obtained by computation;
a classification and association unit configured to determine a category of preset classification information to which the transaction information received from the information extraction unit belongs, and to associate the transaction information with the category; and
an output unit configured to output results that are associated by the classification and association unit.

2. The system of claim 1, further comprising a terminology definition unit configured to store the classification information, and terminology corresponding to the classification information;
wherein the classification and association unit loads the classification information and the corresponding terminology stored in the terminology definition unit, classifies the transaction information received from the information extraction unit based on the classification information, and associates the classified transaction information with a term from the corresponding terminology.

3. The system of claim 2, wherein: the corresponding terminology is baseball terminology; and
the classification and association unit classifies the transaction information based on the classification information, and associates the classified transaction information with the term from the baseball terminology.

4. The system of claim 3, wherein: the transaction information is a fluctuation rate of a stock price, the classification information is a range of a rate of rise, and the term from the baseball terminology is a hit; and
the classification and association unit, if the fluctuation rate of the stock price has risen within the range of a rate of rise in accordance with the classification information, associates the fluctuation rate of the stock price with the baseball term “hit.”

5. The system of claim 3, wherein: the transaction information is a fluctuation rate of a stock price, the classification information is a range of a rate of rise to an upper price limit, and the term from the baseball terminology is a home run; and
the classification and association unit, if the fluctuation rate of the stock price has risen to an upper price limit in accordance with the classification information, associates the fluctuation rate of the stock price with the baseball term “home run.”

6. The system of claim 3, wherein: the transaction information is a fluctuation rate of a stock price, the classification information is part of a range of a rate of rise, and the term from the baseball terminology is an n-base hit (where n is one of 1 to 3); and
the classification and association unit, if the fluctuation rate of the stock price has risen to a specific range of the part of the range of the rate of rise in accordance with the classification information, associates the fluctuation rate of the stock price with the baseball term “n-base hit.”

7. The system of claim 3, wherein: the transaction information is a fluctuation rate of a stock price per trade date, the classification information is a value obtained by dividing a number of dates on which the stock price has risen during a predetermined number of trade dates by a number of trade dates, and the term from the baseball terminology is a batting average; and
the classification and association unit obtains a value by dividing a number of dates on which the stock price has risen during a specific number of trade dates by a number of trade dates based on the fluctuation rate of the stock price per trade date in accordance with the classification information, and associates the obtained value with the baseball term “batting average.”

8. The system of claim 3, wherein: the transaction information is a fluctuation rate of a stock price per trade date, the classification information is rates of rise at which the stock price has risen for a predetermined number of trade dates or a sum of the rates of rise, and the term from the baseball terminology is a score; and
the classification and association unit obtains rates of rise at which the stock price has risen during a specific number of trade dates or a sum of the rates of rise based on the fluctuation rate of the stock price per trade date in accordance with the classification information, and associates the obtained values or value with the baseball term “score.”

9. The system of claim 3, wherein: the transaction information is a fluctuation rate of a stock price per trade date, the classification information is a value obtained by summing rates of rise at which the stock price has risen during a specific number of trade dates and then dividing the sum by a number of risen trade dates, and the term from the baseball terminology is an average score; and
the classification and association unit obtains a value by summing rates of rise at which the stock price has risen during a specific number of trade dates and dividing the sum by a number of risen trade dates based on the fluctuation rate of the stock price per trade date in accordance with the classification information, and associates the value with the baseball term “average score.”

10. The system of claim 3, wherein: the transaction information is a fluctuation rate of a stock price, the classification information is a range of rates of rise and fall, and the term from the baseball terminology is a bunt; and
the classification and association unit, if the fluctuation rate of the stock price indicates that an opening price was below a steady level and a closing price has risen above the steady level in accordance with the classification information, associates the fluctuation rate of the stock price with the baseball term “bunt.”

11. The system of claim 3, wherein: the transaction information is a fluctuation rate of a stock price, the classification information is a range of rates of rise and fall, and the term from the baseball terminology is a bunt failure; and
the classification and association unit, if the fluctuation rate of the stock price indicates that an opening price was above a steady level and a closing price has fallen below the steady level in accordance with the classification information, associates the fluctuation rate of the stock price with the baseball term “bunt failure.”

12. The system of claim 3, wherein: the transaction information is a fluctuation rate of a stock price, the classification information is two partial ranges of a range of rates of rise, and the term from the baseball terminology is a steal; and
the classification and association unit, if the fluctuation rate of the stock price indicates that a rate of rise of an opening price was within a first range and a rate of rise of a closing price has risen to a second range in accordance with the classification information, associates the fluctuation rate of the stock price with the baseball term “steal.”

13. The system of claim 3, wherein: the transaction information is a fluctuation rate of a stock price, the classification information is a partial range of a rate of rise, and the term from the baseball terminology is a home steal; and
the classification and association unit, if the fluctuation rate of the stock price indicates that a rate of rise of an opening price was in a first range and a rate of rise of a closing price has risen to a price limit in accordance with the classification information, associates the fluctuation rate of the stock price with the baseball term “home steal.”

14. The system of claim 3, wherein: the transaction information is a fluctuation rate of a stock price, and the term from the baseball terminology is an n-base hit (where n is one of 1 to 3) if the classification information is a partial range of a rate of rise and a home run if the classification information is a range of a rate of rise to an upper price limit; and
the classification and association unit, if the fluctuation rate of the stock price has risen to a specific partial range of a range of a rate of rise in accordance with the classification information, associates the fluctuation rate of the stock price with the baseball term “n-base hit,” if the fluctuation rate of the stock price has risen to an upper price limit in accordance with the classification information, associates the fluctuation rate of the stock price with the baseball term “home run,” and obtains a value by summing products of weights corresponding the n-base hit and the home run and dividing the sum by a number of trade dates and then associates the value with the baseball term “slugging percentage.”

15. The system of claim 4, wherein the classification and association unit obtains a value by dividing a number of hit dates by a number of trade dates, and associates the value with the baseball term “on-base percentage.”

16. The system of claim 4, wherein the classification and association unit associates a number of consecutive hit dates accumulated for a predetermined number of trade dates starting from a most recent date in a reverse direction, with the baseball term “consecutive hits.”

17. The system of claim 5, wherein the classification and association unit associates a number of consecutive home run dates accumulated for a predetermined number of trade dates starting from a most recent date in a reverse direction, with the baseball term “consecutive home runs.”

18. The system of claim 5, wherein the classification and association unit obtains a value by dividing a number of trade dates on which the stock price has belonged to a specific partial range of a range of a rate of rise and a closing price has corresponded to the home run by a number of trade dates on which the stock price has belonged to the specific range, and associates the value with the baseball term “batting average in scoring position.”

19. The system of claim 3, wherein: the transaction information is a fluctuation rate of a stock price, the classification information is a range of a rate of fall, and the term from the baseball terminology is an out; and
the classification and association unit, if the fluctuation rate of the stock price has fallen to the range of the rate of fall in accordance with the classification information, associates the fluctuation rate of the stock price with the baseball term “out.”

20. The system of claim 3, wherein: the transaction information is a fluctuation rate of a stock price, the classification information is part of a range of a rate of fall, and the term from the baseball terminology is a strikeout, a double play or a triple play; and
the classification and association unit, if the fluctuation rate of the stock price has fallen to a specific partial range of a range of a rate of fall in accordance with the classification information, associates the fluctuation rate of the stock price with the baseball term “strikeout,” “double play” or “triple play.”

21. The system of claim 3, wherein: the transaction information is a fluctuation rate of a stock price, the classification information is a range of rates of rise and fall, and the term from the baseball terminology is a win or a defeat; and
the classification and association unit, if the fluctuation rate of the stock price has risen in accordance with the classification information, associates the fluctuation rate of the stock price with the baseball term “win,” and, if the fluctuation rate of the stock price fallen in accordance with the classification information, associates the fluctuation rate of the stock price with the baseball term “defeat.”

22. The system of claim 3, wherein: the transaction information is a fluctuation rate of a stock price, the classification information is a range of rates of rise and fall, and the term from the baseball terminology is a shutout or a shutout defeat; and
the classification and association unit, if an opening price, low price, high price, closing price of the stock price have risen to an upper price limit, associates the fluctuation rate of the stock price with the baseball term “shutout,” and, if an opening price, low price, high price, closing price of the stock price have fallen to a lower price limit, associates the fluctuation rate of the stock price with the baseball term “shutout defeat.”

23. The system of claim 3, wherein: the transaction information is a fluctuation rate of a stock price per trade date, the classification information is rates of fall at which the stock price has fallen for a predetermined number of trade dates or a sum of the rates of fall, and the term from the baseball terminology is a lost score; and
the classification and association unit obtains rates of fall at which the stock price has risen during a specific number of trade dates or a sum of the rates of fall based on the fluctuation rate of the stock price per trade date in accordance with the classification information, and associates the obtained values or value with the baseball term “lost score.”

24. The system of claim 23, wherein: the transaction information is a fluctuation rate of a stock price per trade date, the classification information is a value obtained by dividing rates of fall at which the stock price fallen during a specific number of trade dates or a sum of the rates of fall by a number of fallen trade dates, and the term from the baseball terminology is an earned run average; and
the classification and association unit obtains a value by dividing rates of fall at which the stock price has fallen during a specific number of trade dates or a sum of the rates of fall by a number of fallen trade dates based on the fluctuation rate of the stock price per trade date in accordance with the classification information, and associates the value with the baseball term “earned run average.”

25. The system of claim 23, wherein: the transaction information is a fluctuation rate of a stock price, the classification information is a range of a rate of fall to a lower price limit, and the term from the baseball terminology is a home run allowed; and
the classification and association unit, if the fluctuation rate of the stock price has fallen to a price limit in accordance with the classification information, associates the fluctuation rate of the stock price with the baseball term “home run allowed.”

26. The system of claim 3, wherein: the transaction information is a fluctuation rate of a stock price, the classification information is a range of rates of rise and fall, and the term from the baseball terminology is a draw; and
the classification and association unit, if the fluctuation rate of the stock price was at a steady level in accordance with the classification information, associates the fluctuation rate of the stock price with the baseball term “draw.”

27. The system of claim 21, wherein the classification and association unit associates a value obtained by dividing a number of winning dates by a sum of the number of winning dates and a number of defeating dates with the baseball term “winning rate.”

28. The system of claim 3, wherein: the transaction information is a fluctuation rate of a stock price, the classification information is a range of rates of rise and fall, and the term from the baseball terminology is a save; and
the classification and association unit, if an opening price of the stock price was within a rise range and a closing price has been equal to or has risen above the opening price, associates the fluctuation rate of the stock price with the baseball term “save.”

29. The system of claim 28, wherein the classification and association unit associates a number of consecutive save dates accumulated for a predetermined number of trade dates starting from a most recent date in a reverse direction, with the baseball term “consecutive saves.”

30. The system of claim 3, wherein: the transaction information is a fluctuation rate of a stock price, the classification information is a range of rates of rise and fall, and the term from the baseball terminology is a blown save; and
the classification and association unit, if an opening price of the stock price was in the range of rise and a closing price thereof has fallen below the opening price, associates the fluctuation rate of the stock price with the baseball term “blown save.”

31. The system of claim 3, wherein: the transaction information is a fluctuation rate of a stock price, the classification information is a range of rates of rise and fall, and the term from the baseball terminology is an away win; and
the classification and association unit, if the stock price has risen on a trade date on which a composite stock index has fallen, associates the fluctuation rate of the stock price with the baseball term “away win.”

32. The system of claim 31, wherein: the classification and association unit obtains a value by dividing a number of away win dates for a predetermined number of dates by a number of dates on which a composite stock index has fallen, and associates the value with the baseball term “away winning rate.”

33. A method of analyzing characteristics of securities information using associated baseball terminology, comprising:
(1) receiving, by an information reception unit of a user terminal, receiving stock information including market price information of a selected item over a communication network;
(2) outputting, by an information extraction unit, transaction information that is extracted from the stock information received by the information reception unit or that is obtained by computation;
(3) determining, by a classification and association unit, a category of preset classification information to which the transaction information received from the information extraction unit belongs, and associating, by the classification and association unit, the transaction information with the category; and
(4) outputting, by an output unit, results that are associated by the classification and association unit.

34. The method of claim 33, further comprising storing, by a terminology definition unit, the classification information, and terminology corresponding to the classification information;
wherein the classification and association unit loads the classification information and the corresponding terminology stored in the terminology definition unit, classifies the transaction information received from the information extraction unit based on the classification information, and associates the classified transaction information with a term from the corresponding terminology.

35. The system of claim 34, wherein: the corresponding terminology is baseball terminology; and
the classification and association unit classifies the transaction information based on the classification information, and associates the classified transaction information with the term from the baseball terminology.
